(19) United States
(12) Patent Application Publication
(10) Pub. No.: US 2010/0107860 A1
(43) Pub. Date: May 6, 2010

(54) SHAPED METAL BODY AND METHOD FOR PRODUCING A SHAPED METAL BODY

(75) Inventors: Franz Dobesberger, Schwarzenau (AT); Herbert J. Flankl, Perg (AT); Dietmar Leitlmeier, Schleisshelm/Wels (AT); Joerg Wellnitz, Walting (DE)

Correspondence Address: GREENBLUM & BERNSTEIN, P.L.C., 1950 ROLAND CLARKE PLACE, RESTON, VA, 20191, US

(73) Assignee: Huette Klein-Reichenbach Gesellschaft m.b.H, Schwarzenau (AT)

(21) Appl. No.: 12/090,009

(22) PCT Filed: Jul. 2, 2007
(86) PCT No.: PCT/AT2007/000327

§ 371 Date: Jun. 30, 2008

(30) Foreign Application Priority Data
Oct. 5, 2006 (AT) A 1670/2006

(51) Int. Cl. F41H 5/04; B22D 19/00; B32B 5/18; B22D 27/00

(52) U.S. Cl. 89/36.02; 164/98; 428/613

(57) ABSTRACT

To increase the strength of a shaped metal body of metal foam, an insert element may be embedded in the shaped metal body. For this purpose, the invention uses as the insert element a freely shearing chain mail of loosely interlinked rings, whereby particularly high strength can be achieved.

### BACKGROUND OF THE INVENTION

1. Field of the Invention

The present invention relates to a multi-layered shaped metal body with a metal foam matrix, in which a one-part or multi-part insert element is embedded, the metal foam matrix and the insert element being positively connected to each other, and relates to a method for producing such a shaped metal body.

2. Description of Background and Other Information

A shaped metal body is disclosed, for example, by DE 203 13 655 U1, which describes a ballistic-resistant element of aluminum foam with a net-like reinforcement embedded in the aluminum foam, the reinforcement being formed as a metal mesh or linked arrangement of steel wire. A metal mesh is in this case a mesh in which a multiplicity of continuous wires are connected to form a linked arrangement. The contact points between the individual wires, in this case, may be rigid or loose. However, when under fire, these continuous wires are subjected to high tensile stresses and elongations by the projectile, bullet, or shell that is to be stopped, and so either a very strong and highly extensible steel wire is required, or the steel wire must be appropriately dimensioned. Although good ballistic resistance can be achieved in this way, it can have the effect of driving up the costs of such a shaped metal body.

### SUMMARY OF THE INVENTION

The present invention provides a shaped metal body that does not have the above disadvantages and, in addition, has even better strength to resist penetrating or impacting bodies, such as the impact of a body, for example, caused by a nearby explosion, or caused by a bullet or shell.

To this end, the insert element according to the invention is formed as a freely shearing chain mail of loosely interlinked rings. A method according to the invention for producing a multi-layered shaped metal body includes the following: providing a mold for the shaped metal body; arranging at least one one-part or multi-part insert element in the form of a freely shearing chain mail of loosely interlinked rings in the mold; melting a metal; introducing gas into the molten metal, in order to make the molten metal foam, thereby producing a flowable metal foam; bringing the flowable metal foam into the mold; and cooling the metal in the mold, the metal solidifying to form the shaped metal body.

Under loading (caused by lateral impact or when under fire), the individual rings of the freely shearing chain mail of linked rings slide on one another in the metal foam matrix. As a result, the loading on the individual ring is greatly reduced, but at the same time the strength of the interlinked structure is increased, since this interlinked structure can dissipate a great amount of energy. With a shaped metal part according to the invention, a very lightweight component with the highest ballistic resistance class B7 can consequently be achieved. Such a shaped metal part may be used, for example, as armoring on vehicles or on buildings, but also as a personal shield.

The effect can be further enhanced if a number of chain mails of linked rings are arranged next to one another or one behind the other in the metal foam matrix, it also being possible for the chain mails of linked rings to be arranged offset in relation to one another.

Depending on the application, the metal foam matrix may have an essentially monomodal pore size distribution. However, the sizes of the pores of the metal foam matrix may also increase gradually from one side face of the shaped metal body to the opposite side face, whereby the strength of the shaped metal body can be further increased.

A further increase in the strength of the shaped metal body is achieved by pretensioning the chain mail of linked rings in the metal foam matrix.

Most particularly for use as ballistic-resistant armoring, it is advantageous if a further layer of a homogeneous and/or isotropic material, such as a sheet of mineral material, is applied to one side face of the shaped metal body, since this breaks up the impacting bullet or shell and changes the path of the bullet or shell, and consequently reduces its effect. For such an application, it is favorable to make this layer face the direction of oncoming fire.

### BRIEF DESCRIPTION OF THE DRAWINGS

The invention is described below on the basis of the schematic, non-restrictive FIGS. 1 to 7, which show advantageous embodiments and in which:

FIG. 1 shows a representation of a multi-layered shaped metal body,

FIGS. 2 to 4 show cross sections of a shaped metal body according to the invention,

FIG. 5 shows a view of an chain mail of linked rings,

FIG. 6 shows examples of possible rings for an chain mail of linked rings, and

FIG. 7 shows a device for producing a shaped metal body according to the invention.

### DETAILED DESCRIPTION OF THE INVENTION

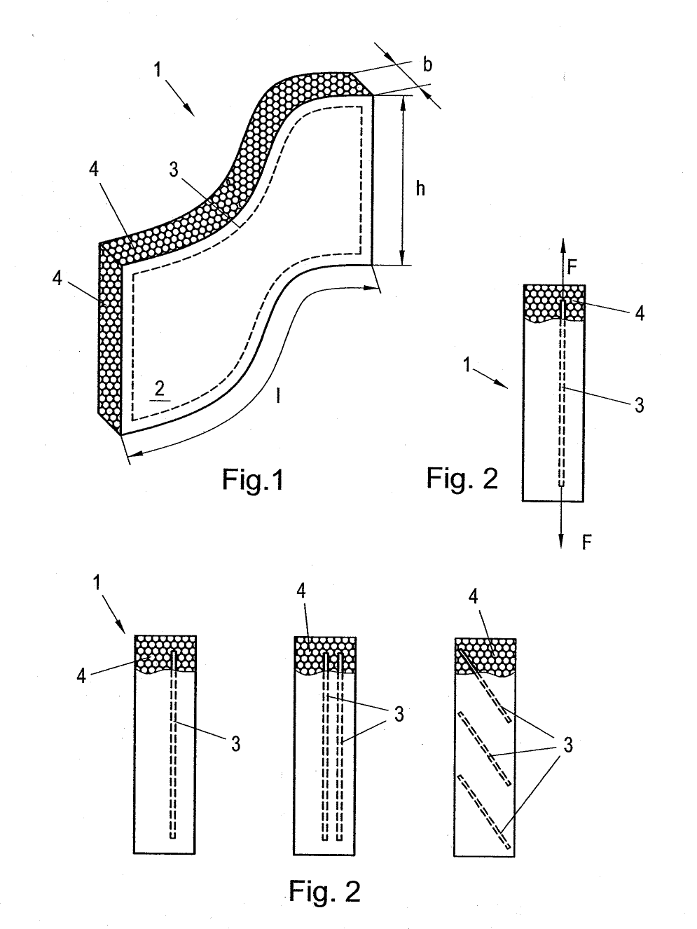

FIG. 1 shows a rigid, sheet-like multi-layered shaped metal body 1, the ratios of length, height, and width advantageously being chosen according to the relationship 1, h>>b, whereby a sheet-like shaped metal body 1 with a side face 2 of a large surface area is obtained. The shaped metal body 1 may in this case be formed as a plate, panel, or dish of any desired curvature and any desired cross section. The shaped metal body 1 essentially comprises a metal foam matrix 4, such as, in a particular embodiment, with aluminum foam, in which one or more, one-part or multi-part insert element 3 is or are embedded. The metal foam 4 and insert element(s) are in this case positively connected to one another and form an interlinked part. On account of the type of production of the shaped metal body 1 (by a molding process), there may also be a certain material bonding by adhesion, but only up to a maximum of about 30% with respect to the strength to resist rupturing and pulling apart.

The insert elements 3 may in this case be arranged in virtually any way desired, as indicated in FIGS. 2 to 4. For example, just a single insert element 3 may be provided at the edge or in the middle of the shaped metal body 1. However, a number of insert elements 3 arranged next to one another or one behind the other may also be provided. Similarly, it is conceivable to arrange insert elements 3 not in such a way that they are essentially parallel to the side face 2 but at a certain angle to it. In precisely this way it is possible to provide for the pretensioning of one or more insert elements 3 with a certain force F before they are embedded in the metal foam matrix 4.

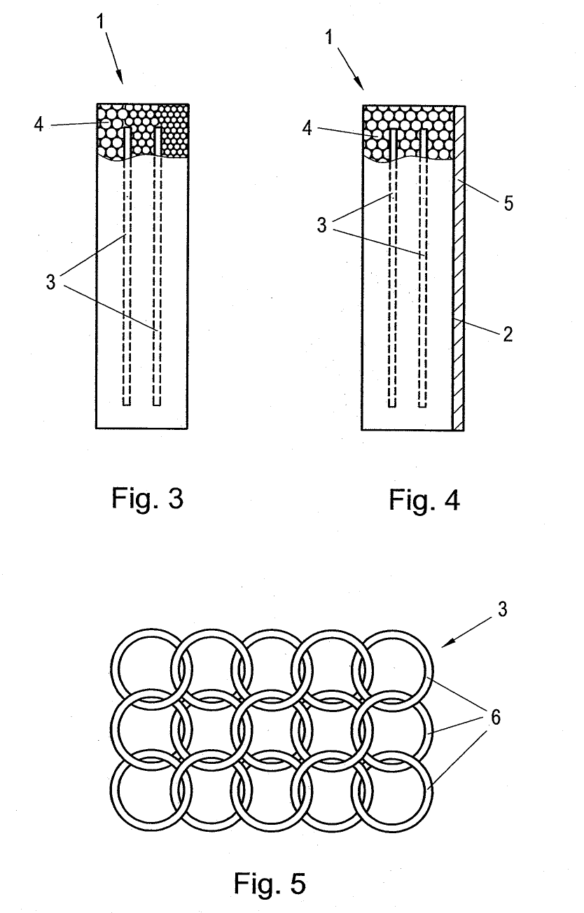

In a particular embodiment according to the invention, the metal foam 4 has an essentially monomodal distribution, i.e., the pores are essentially all of the same size and homogeneously distributed. As an alternative to this, however, the invention encompasses the size of the pores of the metal foam matrix 4 to be increased gradually from one side face 2 of the metal foam body 1 to the opposite side face, as indicated in FIG. 3, which is possible by appropriately controlling the foaming process.

Further, within the scope of the invention, the above configurations and arrangements can be combined in any way desired and in this way make them match a specific application.

Still further according to the invention, an additional layer 5 of a homogeneous and/or isotropic material, optionally with a thin sheet of mineral material, for example of granite or the like, may be applied to one side face 2 by a suitable method, such as for example by material bonding by means of adhesion over the surface area. This layer 5 has a positive effect, in particular in the case of an application as a ballistic-resistant rigid shaped part, since the allowable ballistic resistance class can be increased and the explosive effect reduced or even eliminated as a result. For this purpose, the layer 5 is to be made to face the direction of oncoming fire. Such a layer 5 has the effect that an impacting bullet or shell is broken up and the path of the bullet or shell is changed (essentially by being made to spin upon impact) and in this way the effect is reduced.

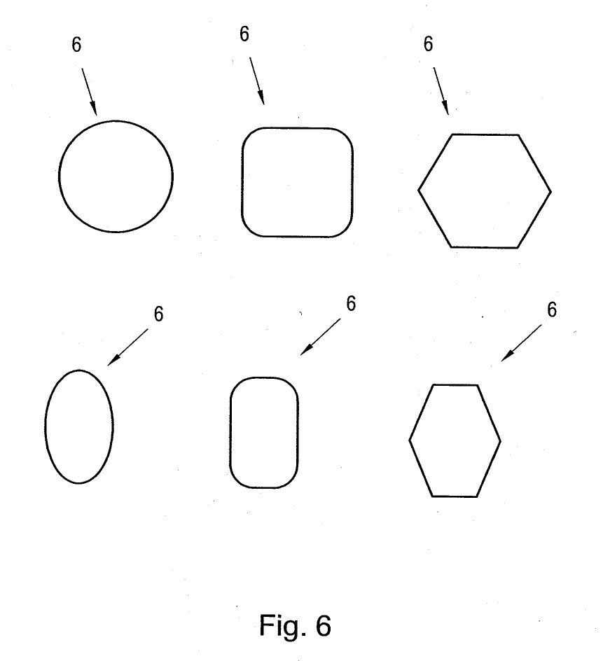

According to the invention, an insert element 3 is formed as a freely shearing chain mail of linked rings, as indicated in FIG. 5. Such chain mail of linked rings in this case comprises a multiplicity of rings 6, which engage in one another, but are otherwise arranged loosely one in the other, that is to say do not have any fixed contact points. Consequently, such chain mail of linked rings can shear completely freely in all directions and, when subjected to loading, the rings 6 slide on one another. The production of such chain mail of linked rings is known per se and is performed for example by welding the individual rings 6 to form a linked chain mail. The chain mail of linked rings may in this case be formed, for example, as a 1:4, 1:6, or 2:8 chain mail, according to the ring-in-ring definition. FIG. 6, examples of possible ring shapes are represented, it also being possible for different ring shapes to be combined in one linked chain mail.

The effect according to the invention is brought about by such a freely shearing chain mail of linked rings in the metal foam matrix 4. Under loading (caused by lateral impact or when under fire), the individual rings 6 slide on one another in the metal foam matrix 4. As a result, the loading on the individual ring 6 is greatly reduced, but at the same time the strength of the interlinked structure is increased, since this interlinked structure can dissipate a great amount of energy. Moreover, the spread of the shock wave in the interlinked structure is significantly reduced and broad crack fronts can form to absorb energy. With a shaped metal part according to the invention, it is consequently possible to achieve a very lightweight component up to the highest ballistic resistance class B7. Such a shaped metal part may be used, for example, as armoring on vehicles or on buildings, but also as a personal shield.

One possible inventive shaped metal body 1 could be formed in this case by a metal foam matrix 4 of aluminum (or some other suitable metal) in which an chain mail of linked rings comprising steel, titanium, or aluminum rings is embedded. The rings may in this case have, for example, an outside diameter of 3-20 mm (depending on the application) and the pore size of the metal foam matrix 4 is also chosen according to the application, for example a pore size of up to 30 mm. The thicknesses of the rings may be chosen, for example, between 1 and 2 mm. The chain mail of linked rings may also be surface-treated and hardened. The pretensioning of a chain mail of linked rings in the metal foam matrix 4 may be, for example, 1 kN. Such an arrangement is suitable as a ballistic-resistant shaped metal part for 1 kg of TNT at a range of 5 m or 15 kg of plastic explosive at a range of 15 m.

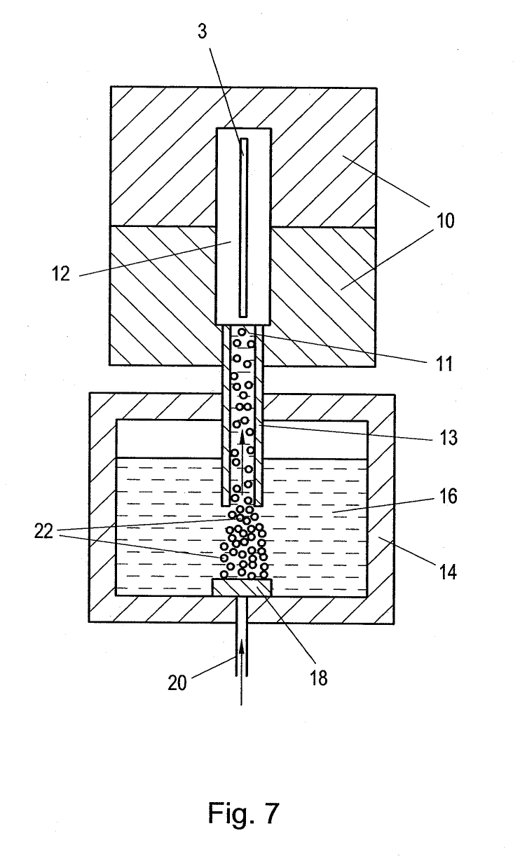

The production of a shaped metal part 1 according to the invention is described below with reference to FIG. 7.

One or more, one-part or multi-part insert element(s) 3 in the form of a freely shearing chain mail of loosely interlinked rings 6 is or are arranged in a two-part mold 10 in the desired position within a cavity 12, which predetermines the outer shape of the shaped metal part. The insert element 3 may in this case also be pretensioned with a certain force. In a furnace 14, metal, for example aluminum, is heated and brought into a liquid state. The cavity 12 of the mold 10 is connected to the furnace 14 via a filling opening 11 and a filler piece 13 (or a similar device). The filler piece 13 thereby dips into the liquid metal bath 16 in the furnace 14. Also provided in the furnace 14, underneath the filler piece 13, is a foaming device 18, such as for example a nozzle arrangement or an impeller. Suitable foaming devices and foaming methods are described, for example, in the patents EP 1 288 320 B1 and EP 1 419 835 B1, commonly owned herewith. Gas, such as air, is fed via a supply line 20 to the foaming device 18, the air exiting the foaming device to enter the liquid metal bath 16 and to form bubbles 22 in the metal bath. The bubbles 22 rise in the metal bath 16 and in the filler piece 13 (indicated by the arrow in FIG. 7) and then reach the cavity 12 of the mold 10. The foaming operation is carried out as long as it takes for the entire cavity 12 to be filled with bubbles 22 or with metal foam 4. The metal foam may in this case be forced into the cavity 12 of the mold 10, for example by exerting a pressure on the metal bath 16. As a result, the insert part(s) 3 is or are surrounded, at least partially, but, in a particular embodiment, completely, by liquid metal foam and embedded in the metal foam matrix 4. Under some circumstances, necessary vents may also be provided between the mold 10 or the furnace 14 and the outside world, in order to bring about pressure equalization during filling. After the foaming operation, the cavity 12 may be closed and the mold 10 removed for cooling.

After filling, the mold 10 or the shaped metal body 1 located in the mold is cooled until the liquid metal foam has solidified and forms the metal foam matrix 4. After that, the mold 10 can be opened and the finished shaped metal body 1 removed.

In principle, however, it is possible to fill the cavity 12 of the mold 10 partially or completely with liquid metal before the foaming, for example by exerting a pressure on the liquid metal bath 16, whereby the level of the liquid in the filler piece 13, and consequently also in the cavity 12, rises. If the liquid metal is then made to foam, as described above, the bubbles 22 again rise up and thereby displace the liquid metal in the cavity 12, until the latter is completely filled with metal foam to form the metal foam matrix 4. For this purpose, a certain pressure equalization may also be provided, in order to ensure uniform foam formation, for example by slowly raising the mold during the foaming operation or by slowly lowering the pressure on the metal bath 16.

However, the foaming process may also be controlled in such a way that the shaped metal body 1 has regions with metal foam and regions of compact metal lying next to one another. For this purpose, suitable separating elements may also be arranged in the mold 10.

The foaming operation and the molding operation, according to the invention, can be separated. For this purpose, metal foam may be produced in a separate device, such as a furnace 14, for example by conventional known methods, and this metal foam transported to a separate mold 10 by a suitable device, such as for example a scoop or a trowel. There, the liquid metal foam can be filled into the cavity 12 of the mold 10. This may take place, for example, by forcing the liquid metal foam into the cavity 12 of the mold, for example by means of a ram.

1-17. (canceled)

18. A multi-layered shaped metal body comprising:
a foam matrix;
at least one insert element embedded within the foam matrix;
the metal foam matrix and the insert element being positively connected to each other;
the insert element comprises a freely shearing chain mail of loosely interconnected rings.

19. A multi-layered shaped metal body according to claim 18, wherein:
the at least one insert element embedded within the foam matrix consists of one insert element embedded within the foam matrix.

20. A multi-layered shaped metal body according to claim 18, wherein:
the at least one insert element embedded within the foam matrix comprises a a plurality of insert elements embedded within the foam matrix.

21. A multi-layered shaped metal body according to claim 18, wherein:
the metal foam matrix and the freely shearing chain mail of loosely interconnected rings are positively connected to form an interlinked part.

22. A multi-layered shaped metal body according to claim 18, wherein:
a plurality of insert elements are arranged next to one another or one behind another within the metal foam matrix.

23. A multi-layered shaped metal body according to claim 18, wherein:
the metal foam matrix has an essentially monomodal pore size distribution.

24. A multi-layered shaped metal body according to claim 18, wherein:
the metal form matrix has pores, said pores having sizes increasing gradually from one side face of the shaped metal body an opposite side face.

25. A multi-layered shaped metal body according to claim 18, wherein:
the insert element within the metal foam matrix is pretensioned.

26. A multi-layered shaped metal body according to claim 18, further comprising:
a further layer applied to one side face of the shaped metal body, said further layer comprising a homogeneous and/or isotropic material.

27. A multi-layered shaped metal body according to claim 26, wherein:
the further layer is formed as a sheet of mineral material.

28. A method of using a multi-layered shaped metal body according to claim 18, said method comprising:
using the multi-layers shaped metal body as a ballistic-resistant rigid shaped part.

29. A method of using a multi-layered shaped metal body according to claim 28, wherein the metal body further comprises a further layer applied to one side face of the shaped metal body, said further layer comprising a homogeneous and/or isotropic material, said method further comprising:
facing the further layer in a direction of oncoming fire.

30. A method for manufacturing a multi-layered shaped metal body, said method comprising:
providing a mold for the shaped metal body;
arranging at least one one-part or multi-part insert element in the form of a freely shearing chain mail of loosely interlinked rings in the mold;
melting a metal;
introducing gas into the molten metal, in order to make the molten metal foam, thereby producing a flowable metal foam;
bringing the flowable metal foam into the mold; and
cooling the metal in the mold, the metal solidifying to form the shaped metal body.

31. A method for manufacturing a multi-layered shaped metal body according to claim 30, wherein:
the bringing the flowable metal foam into the mold comprises forcing or filling the flowable metal foam into the mold.

32. A method for manufacturing a multi-layered shaped metal body according to claim 30, further comprising:
arranging the mold with a filling opening above the metal melt;
connecting a cavity of the mold to a filler piece in a way to provide a liquid metal seal, with the filler piece protruding into the metal melt;
wherein the bringing the flowable metal foam into the mold comprises directing the flowable metal foam into the cavity of the mold through the filler piece.

33. A method for manufacturing a multi-layered shaped metal body according to claim 27, further comprising:
arranging the mold with a filling opening above the metal melt;
connecting a cavity of the mold to a filler piece in a way that provides a liquid metal seal, with the filler piece protruding into the metal melt;
causing the liquid metal melt to rise up through the filler piece and the filling opening into the cavity of the mold;
causing the metal melt in the cavity to be displaced by the flowable metal foam.

34. A method for manufacturing a multi-layered shaped metal body according to claim 30, further comprising:
pretensioning at least one insert element before introducing the flowable metal foam.

35. A method for manufacturing a multi-layered shaped metal body according to claim 30, further comprising:
controlling the foaming operation in such a way that pores of the metal foam have a size increasing gradually or decreasing gradually during the foaming.

36. A method for manufacturing a multi-layered shaped metal body according to claim 30, further comprising:
applying a further layer of a homogeneous and/or isotropic material to one side face of the solidified shaped metal body.
